(19) United States
(12) Patent Application Publication
(10) Pub. No.: US 2023/0357096 A1
(43) Pub. Date: Nov. 9, 2023

(54) METHOD FOR MANUFACTURING ORGANIC LIQUID FERTILIZER

(71) Applicant: Digested Organics LLC, Plymouth, MI (US)

(72) Inventor: Robert Levine, Ann Arbor, MI (US)

(21) Appl. No.: 18/314,309

(22) Filed: May 9, 2023

Related U.S. Application Data
(60) Provisional application No. 63/339,802, filed on May 9, 2022.

(51) Int. Cl. C05F 3/00

(52) U.S. Cl. CPC C05F 3/00

(57) ABSTRACT

Systems and methods for manufacturing an organic liquid fertilizer product are shown. The contemplated systems and methods are configured to treat waste from a natural source in order to produce an organic liquid fertilizer. The liquid organic waste may be derived from an organic source. The liquid organic waste may be pre-treated through an anaerobic digestion process, or it may be treated in a raw form. Advantageously, the systems and methods of the present disclosure may be used to manufacture the organic liquid fertilizer with a sufficiently high nitrogen content, which is usable by plants and crops. The systems and methods are likewise more efficient than known systems and methods to produce such fertilizer products.

### CROSS REFERENCE TO RELATED APPLICATIONS

This application claims the benefit of U.S. Provisional Application No. 63/339,802, filed on May 9, 2022, which is incorporated herein by reference in its entirety.

### FIELD

The present disclosure relates generally to a fertilizer and, more particularly, to a method for manufacturing a liquid fertilizer rich in ammonia nitrogen suitable for use in organic crop production.

### BACKGROUND

Nitrogen is an essential nutrient for plants as a major component of chlorophyll, amino acids, adenosine triphosphate (ATP), and nucleic acids. the building blocks of proteins. Plants absorb nitrogen as either ammonium (NH₄⁺) or nitrate (NO₃⁻), but it is difficult for producers of organic fruits, vegetables, and crops to find cost-effective and allowed fertilizers comprised of these inorganic, plant-available nitrogen sources.

One known type of fertilizer, for example, is Chilean nitrate. This fertilizer is a mined source of inorganic nitrogen. However, Chilean nitrate is expensive and restricted under the National Organic Program (NOP) in the United States to not more than 20% of the total nitrogen budget per cropping cycle.

Another commonly used source of nitrogen for organic farms is manure. However, this fertilizer is typically quite dilute (i.e., less than 1% total nitrogen), contains a large fraction of organic nitrogen that is not immediately plant-available, and is not economical to haul far distances.

Organic fertilizers have also been derived from manure that has been processed. For example, U.S. Pat. No. 10,023,501 to Crabtree describes a method of producing a liquid fertilizer that involves filtering organic waste, acidifying it, and removing water through thermal evaporation. However, this process is expensive due to the high cost of acidification and evaporation, and it is limited to producing a fertilizer with about 4 to 6% total nitrogen.

Accordingly, there is a continuing need for a method of manufacturing an ammonia fertilizer that is suitable for use in organic agriculture, and which is highly concentrated. Desirably, the resultant ammonia fertilizer contains predominantly plant available ammonium, and is economical to produce from natural materials.

### SUMMARY

In concordance with the instant disclosure, a method of manufacturing an organic fertilizer with a high nitrogen content that is usable by plants and crops, which is highly concentrated, contains predominantly plant available ammonium, and is economical to produce from natural materials, has been surprisingly discovered.

In one embodiment, a method for manufacturing a liquid fertilizer includes the steps of obtaining a liquid organic waste such as manure, removing the suspended solids, heating the clarified liquid waste to remove water vapor and volatile compounds, condensing the water vapor and volatile compounds to form a first condensate, heating the first condensate to remove water vapor and volatile compounds, and finally condensing the water vapor and volatile compounds to form a second condensate rich in ammoniacal nitrogen.

In another embodiment, a system for manufacturing the liquid fertilizer product may include a waste tank. The waste tank may be configured to hold a liquid organic waste that contains ammoniacal nitrogen. As non-limiting examples, the liquid organic waste may be derived from livestock manure, such as dairy manure or pig manure, or food waste. A filter may be in communication with the waste tank. The filter may be configured to remove suspended solids from the organic waste to obtain a clarified liquid organic waste. A heater may be in communication with the filter or another tank to hold the clarified liquid organic waste. The heater may be configured to heat the clarified liquid organic waste to remove water vapor and volatile compounds. A condenser may be in communication with the heater to condense the water vapor and volatile compounds to obtain a first liquid condensate. A second heater may be in communication with the condenser or another tank that holds the first liquid condensate. The second heater may be configured to remove water vapor and volatile compounds. A second condenser may be in communication with the second heater to condense the water vapor and volatile compounds to obtain a second liquid condensate. The liquid fertilizer product has a nitrogen content greater than 5% by weight relative to the total weight of the liquid fertilizer product is manufactured.

In yet a further embodiment, a liquid fertilizer product derived from manure includes an aqueous solution having a nitrogen content greater than 10% by weight relative to the total weight of the liquid fertilizer product.

The present disclosure provides for a method for manufacturing a liquid fertilizer product, including the steps of obtaining a liquid organic waste; removing suspended solids from the liquid organic waste to obtain a clarified liquid organic waste; heating the clarified liquid organic waste to remove water vapor and volatile compounds, obtaining a salt-rich first concentrate; condensing the water vapor and volatile compounds to obtain a first condensate; heating the first condensate to remove water vapor and volatile compounds, obtaining a second concentrate; and condensing the water vapor and volatile compounds to obtain a second condensate.

The present disclosure also provides for a method for manufacturing a liquid fertilizer product further including the step of removing water from the first condensate through membrane filtration to obtain a concentrated first condensate prior to heating the first condensate.

The present disclosure also provides for a liquid fertilizer product obtained by the methods herein having a total nitrogen content greater than 5% nitrogen.

The present disclosure also provides for a method for manufacturing a liquid fertilizer product further including the step of adjusting the pH of the first condensate prior to membrane concentration or the second heating by adding an acidic substance, such as citric acid, acetic acid, elemental sulfur, sulfuric acid, stillage (from ethanol production), or nitric acid.

The present disclosure also provides for a method for manufacturing a liquid fertilizer product further including the step of adjusting a concentration of ammoniacal nitrogen in the liquid organic waste before removing suspended solids from the liquid organic waste to obtain the clarified liquid organic waste.

The present disclosure also provides for a method for manufacturing a liquid fertilizer product wherein the step of adjusting the concentration of ammoniacal nitrogen includes at least one of a microfiltration process, ultrafiltration process, forward osmosis process, a reverse osmosis process, an anaerobic digestion process, an aerobic microbial process, an evaporation process, or a microbial fermentation process.

The present disclosure also provides for a method for manufacturing a liquid fertilizer product further including the step of adjusting a concentration of ammoniacal nitrogen in the liquid organic waste after removing suspended solids but before heating the clarified liquid waste.

The present disclosure also provides for a method for manufacturing a liquid fertilizer product wherein the step of adjusting the concentration of ammoniacal nitrogen includes at least one of a microfiltration process, ultrafiltration process, forward osmosis process, a reverse osmosis process, an anaerobic digestion process, an aerobic microbial process, an evaporation process, or a microbial fermentation process.

The present disclosure also provides for a method for manufacturing a liquid fertilizer product wherein the step of removing suspended solids includes at least one of microfiltration, ultrafiltration, or combinations thereof.

The present disclosure also provides for a method for manufacturing a liquid fertilizer product wherein the liquid organic waste is one of livestock manure and food waste, which is provided one of raw or anaerobically digested.

The present disclosure also provides for a method for manufacturing a liquid fertilizer product wherein more than one of the salt-rich first concentrate, the second condensate, and the second concentrate are combined to some degree to create a mixture for use as a fertilizer.

The present disclosure also provides for a method for manufacturing a liquid fertilizer product wherein the salt-rich first concentrate is dehydrated through centrifugation, filter pressing, or drying to create a semi-solid or solid product.

The present disclosure also provides for a system for manufacturing a liquid fertilizer product including a waste tank configured to hold a liquid organic waste; a filter in communication with the waste tank, and configured to filter the organic waste to obtain a clarified liquid organic waste; a first heater receiving the clarified liquid organic waste, and configured to heat the clarified liquid organic waste to remove water vapor and volatile compounds, obtaining a salt-rich first concentrate; a condenser configured to condense the water vapor and volatile compounds to obtain a first condensate; a second heater receiving the first condensate, and configured to heat the first condensate to remove water vapor and volatile compounds, obtaining a second concentrate; and a second condenser configured to condense the water vapor and volatile compounds to obtain a second condensate.

The present disclosure also provides for a system for manufacturing a liquid fertilizer product wherein the filter is one of an ultrafilter or a microfilter.

The present disclosure also provides for a system for manufacturing a liquid fertilizer product wherein the liquid organic waste is one of livestock manure or food waste, which is provided one of raw or anaerobically digested.

The present disclosure also provides for a system for manufacturing a liquid fertilizer product wherein more than one of the salt-rich first concentrate, the second condensate, and the second concentrate are combinable to create a mixture for use as a fertilizer.

The present disclosure also provides for a system for manufacturing a liquid fertilizer product wherein the mixture has a total nitrogen content greater than 5% nitrogen.

The present disclosure also provides for a system for manufacturing a liquid fertilizer product further including a dehydrator, the dehydrator configured to dehydrate the salt-rich first concentrate to create a semi-solid or solid product.

The present disclosure also provides for a method for manufacturing a liquid fertilizer product wherein the dehydrator utilizes centrifugation, filter pressing, or drying.

The present disclosure also provides for a system for manufacturing a liquid fertilizer product further including a microbial reactor configured to process the clarified liquid waste and adjust the concentration of ammonia present prior to introduction into the first heater.

The present disclosure also provides for a method for manufacturing a liquid fertilizer product including the steps of obtaining a liquid organic waste; heating the clarified liquid organic waste to remove water vapor and volatile compounds, obtaining a salt-rich first concentrate; condensing the water vapor and volatile compounds to obtain a first condensate; heating the first condensate to remove water vapor and volatile compounds, obtaining a second concentrate; and condensing the water vapor and volatile compounds to obtain a second condensate.

Any combination or permutation of embodiments is envisioned. Additional advantageous features, functions and applications of the disclosed facial masks, assemblies and methods of the present disclosure will be apparent from the description which follows, particularly when read in conjunction with the appended figures. All references listed in this disclosure are hereby incorporated by reference in their entireties.

### DRAWINGS

The above, as well as other advantages of the present disclosure, will become readily apparent to those skilled in the art from the following detailed description, particularly when considered in the light of the drawings described hereafter.

Exemplary embodiments of the present disclosure are further described with reference to the appended figures. It is to be noted that the various features, steps, and combinations of features/steps described below and illustrated in the figures can be arranged and organized differently to result in embodiments which are still within the scope of the present disclosure. To assist those of ordinary skill in the art in making and using the disclosed facial masks, assemblies and methods, reference is made to the appended figures, wherein:

FIG. 1 is a schematic diagram illustrating a system for manufacturing an organic liquid fertilizer product, according to one embodiment of the present disclosure;

FIG. 2 is a schematic diagram illustrating a method for manufacturing the organic liquid fertilizer product with the system shown in FIG. 1, according to another embodiment of the present disclosure;

FIG. 3 is a schematic diagram illustrating a system for manufacturing an organic liquid fertilizer product, according to a further embodiment of the present disclosure;

FIG. 4 is a schematic diagram illustrating a method for manufacturing the organic liquid fertilizer product with the system shown in FIG. 3, according to yet another embodiment of the present disclosure;

FIG. 5 is a schematic diagram illustrating a water reclamation system of the system for manufacturing an organic liquid fertilizer product, for use in the systems and methods shown in FIGS. 1-4, according to a further embodiment of the present disclosure; and

FIGS. 6-10 are schematic diagrams illustrating a system for manufacturing an organic liquid fertilizer product, according to further embodiments of the present disclosure.

### DETAILED DESCRIPTION

The following description is merely exemplary in nature and is not intended to limit the present disclosure, application, or uses. It should be understood that throughout the drawings, corresponding reference numerals indicate like or corresponding parts and features. In respect of the methods disclosed, the order of the steps presented is exemplary in nature, and thus, is not necessary or critical unless otherwise disclosed.

Throughout the description, various dimensions, units of measure, volumes, and quantities are also disclosed; however, it should be appreciated that these features are being provided for purposes of illustrating various examples, and one of ordinary skill in the art may select other suitable dimensions, units of measure, volumes, and quantities within the scope of the instant disclosure.

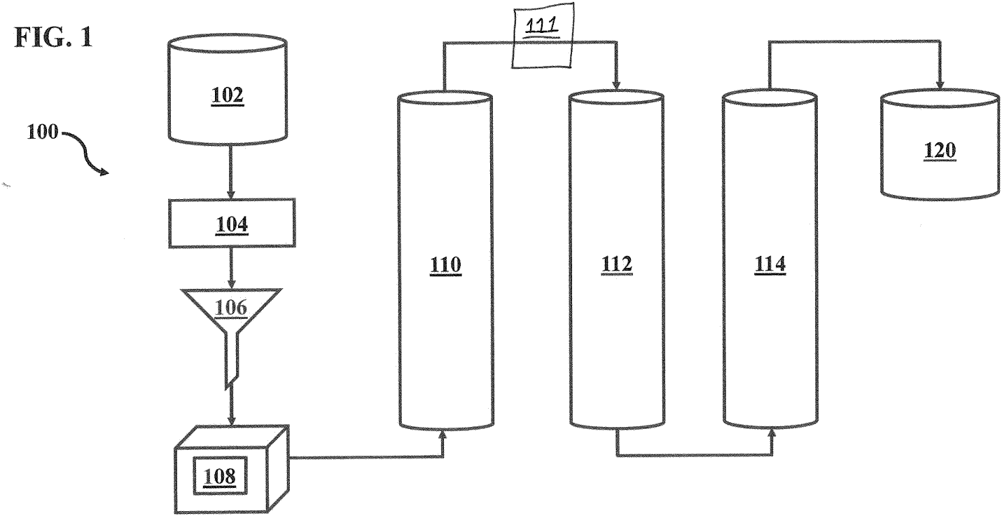

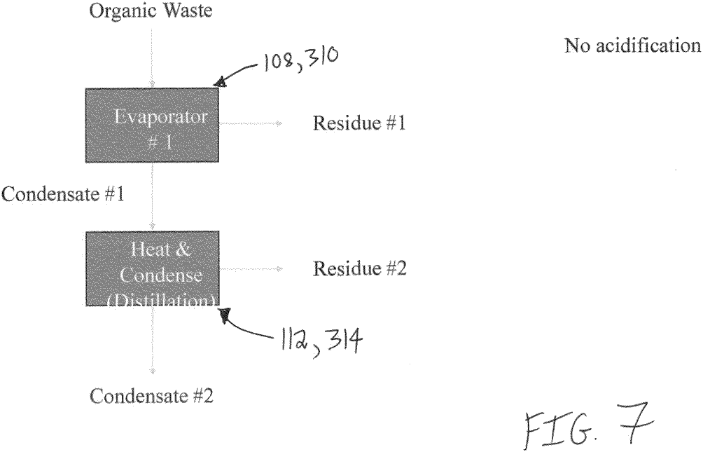

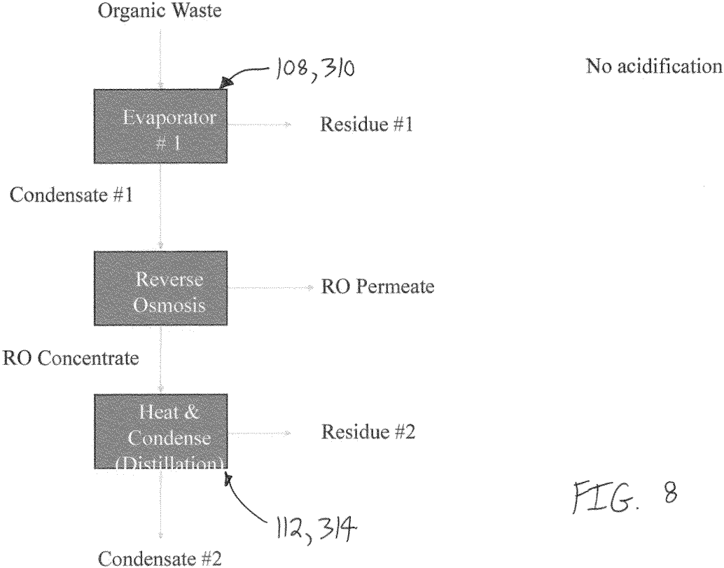

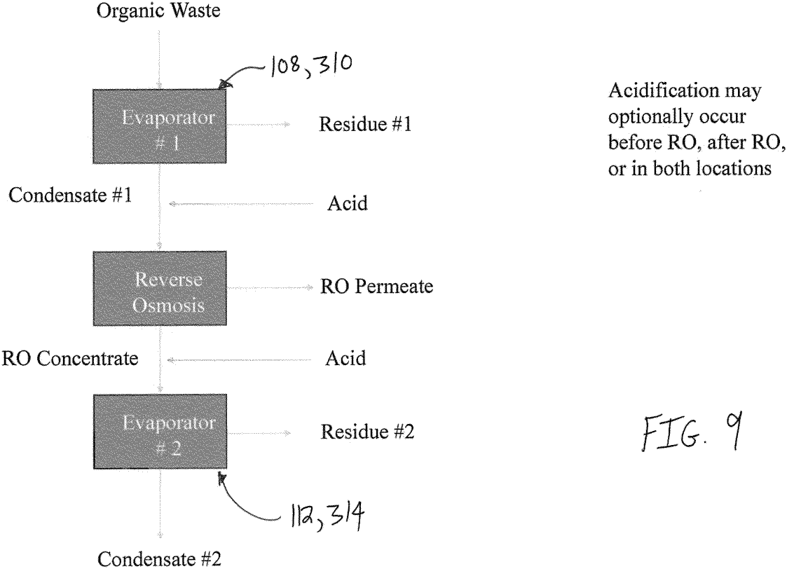

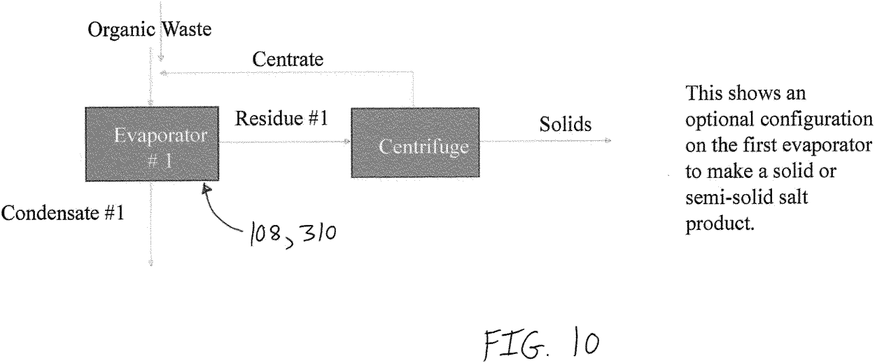

The present disclosure includes systems 100, 300 and methods 200, 400 for manufacturing an organic liquid fertilizer product, as shown in FIGS. 1-10. The contemplated systems 100, 300 and methods 200, 400 are configured to treat waste from a natural source in order to produce the organic liquid fertilizer product. The liquid fertilizer product is, in particular, an aqueous solution containing liquid ammonia derived from the natural source of waste. The ammonia in liquid solution may also be referred to herein as “aqueous ammonia” and “ammonium hydroxide.”

In certain embodiments, as shown in FIGS. 1-10, the waste is a liquid organic waste that may be derived from an organic source. For example, the liquid organic waste may be derived from natural sources including, but not limited to, plant and animal-biproducts, rock powders, seaweed, inoculants, conditioners, dairy product waste, livestock manure (e.g., dairy manure, chicken manure, or swine manure), liquid manure, worm castings, peat, guano, compost, blood meal, bone meal, fish meal, decomposing crop residue, cheese whey, dairy product waste, dry chicken manure, mixed liquor from food and livestock processing facilities, wastewaters from a variety of food processing operations, and combinations thereof. However, it should be appreciated that any natural source that contains ammoniacal nitrogen may be chosen by one skilled in the art.

More particularly, the liquid organic waste may be any aqueous solution that contains a dissolved protein, ammoniacal nitrogen, and other soluble nutrients derived from natural sources. If the organic waste is in a solid or semi-solid form, water may be added to the solid or semi-solid material beforehand to form the fluid mixture. For example, in an embodiment where dry or semi-dry animal manure is utilized, water may be added to form a fluid mixture creating the liquid organic waste. The water thereby creates the fluid mixture of water and suspended plus dissolved solids to form the liquid organic waste.

It should also be appreciated that the liquid organic waste may be pre-treated through an anaerobic digestion or other microbial fermentation process to provide an effluent discharge as the liquid organic waste, or it may be used in a raw form in the system 100/300 and method 200/400, as desired.

In one embodiment, as shown in FIG. 1, a system 100 for manufacturing the organic liquid fertilizer product may produce the liquid fertilizer product from a liquid organic waste that contains ammoniacal nitrogen. The system 100 may include a waste tank 102, a concentrator 104, a filter 106, a first heater/evaporator 108, a first condenser 110, a second heater/evaporator 112, a second condenser 114, and a collection tank 120, each of which may be placed in selective communication via conducts such as pipes, pumps, motors, valves, and the like, which may be selected by the skilled artisan within the scope of the present disclosure.

The system 100 may also be provided with a controller (not shown) and sensors (not shown) that will permit a user to monitor and regulate an operation of the system 100, as desired. The controller can include a processor and a memory having tangible and non-transitory processor-executable instructions that are embodied thereon. The controller may also be in communication with one or more user interfaces (not shown) such as screens, keyboards, dials, buttons, and the like, which permit the user to interact with and regulate the operation of the system 100 in accordance with the method 200 described further herein. Other suitable types of controllers, sensors, and user interfaces may also be employed, as desired.

The waste tank 102, shown in FIG. 1, may be configured to hold the liquid organic waste. In particular examples, the liquid organic waste may be derived from livestock manure, such as dairy manure or pig manure, or food waste. In a most particular example, the waste tank may include a manure holding tank that receives and maintains, for example, with an optional heating equipment, the liquid organic waste at approximately 104° F. However, one of ordinary skill in the art may also select other suitable sources and holding containers for the liquid organic waste within the scope of the present disclosure.

With continued reference to FIG. 1, the system 100 may have the concentrator 104. The concentrator 104 may be configured to receive and adjust the liquid organic waste from the waste tank 102. In particular, the concentrator 104 may be configured to adjust a concentration of ammonia within the organic liquid waste. Advantageously, the concentrator 104 may reduce an overall volume of liquid, which thereby reduces a total load on the system 100. The reduction in the total load on the system 100 allows the system 100 to be more efficient and economical compared to the system 100 without a concentrator 104.

More particularly, the concentrator 104 may be configured to increase the concentration of ammonia in the liquid organic waste. The concentrator 104 may provide this increase in concentration by either removing liquid devoid of ammonia from the liquid organic waste or increasing the availability of ammonia in the liquid organic waste by converting organic sources of ammoniacal nitrogen, such as proteins and amino acids, to ammonia.

Suitable mechanisms for the concentrator 104 may include heat treatment in a tank, natural acid hydrolysis through fermentation, fermentation in the presence of ammonia producing organisms, fermentation in the presence of ammonia oxidizing bacteria, anaerobic digestion, aerobic digestion, forward osmosis, reverse osmosis, evaporation, and combinations thereof. For example, livestock manure when anaerobically digested at between 95° F. and 103° F. for at least 10 days typically has a higher ammonia nitrogen content compared to raw untreated manure as some organic nitrogen is converted into ammonium in the liquid waste. A skilled artisan may select other suitable mechanisms for the concentrator 104 within the scope of the present disclosure in order to increase the concentration of ammonia within the liquid organic waste.

Referring still to FIG. 1, the filter 106 may be in communication with the waste tank 102 and the concentrator 104. The filter 106 may be configured to filter the organic waste to obtain a clarified liquid organic waste. Particularly, the filter 106 may be configured to remove suspended solids from the liquid organic waste. The suspended and dissolved solids in the liquid waste may include, but are not limited to nitrogen, phosphorus, potash, secondary nutrients, micro-nutrients and organic matter found in anaerobically digested manure or other agriculturally related organic waste. It should be appreciated that adjusting the temperature of the organic waste may facilitate filtration as well as the dissolution of particulate organic waste into the aqueous solution. Advantageously, the removal of the suspended solids from the liquid organic waste may mitigate against undesirable clogging in the system 100 in operation as well as the presence of undesirable particulate matter in the final fertilizer product.

It should be appreciated that the suspended solids may be removed by the filter 106 via one or more filtration mechanisms including, but not limited to, mechanical screening, microfiltration, ultrafiltration, nanofiltration, reverse osmosis, membrane separation, highspeed mixing (e.g., hydrocyclone), centrifugation, ultrasound and electro-coagulation. It should also be appreciated that a combination of filtration mechanisms may be employed for the filter 106. Natural settling, such as may occur in a lagoon, pond, or tank, is also envisioned as a mechanism to create a clarified liquid organic waste with lower amounts of suspended solids. The liquid organic waste may also be electrified or magnetized to crystalize minerals and reduce scaling on process equipment. Suitable types of filtration will be selected by one skilled in the art, for example, depending on conditions and desired processing considerations within the scope of the present disclosure. It should also be understood that, for wastes with very low levels of suspended solids, no filtration may be required.

In certain embodiments, the filter 106 may be capable of removing suspending solids that are larger than from about 1 micron to about 0.02 microns. In certain embodiments, the filter 106 may be a microfilter. The microfilter may be capable of removing suspended solids larger than about 0.1 to 0.5 microns. In further embodiments, the filter 106 may be an ultrafilter. The ultrafilter may be capable of removing solids larger than about 0.01 to 0.05 microns. A skilled artisan may select other suitable filtration methods and acceptable particle sizes, as desired.

It should be understood that a combination of the concentrator 104 and the filter 106 of the system 100 may produce a clarified liquid organic waste. The clarified liquid organic waste has a desirably low suspended solids content and a desirably high concentration of ammonia. Advantageously, the clarified liquid organic waste may not only run more efficiently through a remainder of the system 100, but may also produce an organic liquid fertilizer product which has a greater concentration of aqueous nitrogen compared to known waste treatment systems.

As further shown in FIG. 1, the system 100 may further include a first heater or evaporator 108. The heater or evaporator 108 is configured to receive the clarified liquid organic waste. For example, the heater/evaporator 108 may be in communication with the filter 106. In another example, the heater/evaporator 108 may be in communication with a holding tank for the clarified liquid organic waste. The heater/evaporator 108 may further be configured to heat the clarified liquid organic waste to a temperature above 100° F. More particularly, the heater/evaporator 108 may be configured to heat the clarified liquid organic waste to a temperature above 140° F. Most particularly, the heater/evaporator 108 may be configured to heat the clarified liquid organic waste to a temperature of at least 165° F. or greater, for example, in order to comply with regulatory requirements and show pathogen kill for manure-derived and food waste-derived products. The heater/evaporator 108 may be operated at atmospheric pressure or under vacuum. At these temperatures and pressures, the heater/evaporator 108 may be configured to raise the temperature of the clarified liquid organic waste to a predetermined temperature that facilitates the removal of water vapor and volatile compounds, including ammonia, from the clarified liquid organic waste. The heater/evaporator 108 should be understood to include any suitable heating method known in the art, and a skilled artisan may also select any suitable predetermined temperature to which to heat the clarified liquid organic waste.

As further shown in FIG. 1, the first condenser 110 may be in communication with the first heater/evaporator 108. The water vapor and volatile compounds produced by the heater/evaporator 108 are condensed into a liquid form in the first condenser 110 and form the first condensate. The first condenser 110 should be understood to include any suitable condensing apparatus known in the art, and a skilled artisan may also select any suitable predetermined temperature and pressure at which to operate the first condenser. The liquid material that does not volatilize or evaporate is the first concentrate, which can be further dehydrated to a dry or semi-dry solid fertilizer or mixed with other products of the system 100.

As further shown in FIG. 1, a second heater 112 may be in communication with the first condenser 110 or a holding tank containing the first condensate. The second heater 112 may be operated at atmospheric pressure or under vacuum and may be configured to raise the temperature of the first condensate to a predetermined temperature that facilitates the removal of water vapor and volatile compounds, including ammonia. The second heater 112 should be understood to include any suitable heating method known in the art, and a skilled artisan may also select any suitable predetermined temperature and pressure to which to heat the clarified first condensate. The liquid material that does not volatilize or evaporate is the second concentrate, which can be further dehydrated to a dry or semi-dry solid fertilizer or mixed with other products of the system 100.

As further shown in FIG. 1, the second condenser 114 may be in communication with the second heater 112. The water vapor and volatile compounds produced by the second heater 112 are condensed into a liquid form in the second condenser 110 and form the second condensate. The second condenser 114 should be understood to include any suitable condensing apparatus known in the art, and a skilled artisan may also select any suitable predetermined temperature and pressure at which to operate the first condenser. Likewise, it should be appreciated that the present system 100 and the combination of the second heater 112 and second condenser 114 may employ the use of a rectifier (i.e., a boiler-condenser) for thermal concentration.

In one embodiment, the pH of the waste in the waste tank 102 or the concentrator 104 may be adjusted to facilitate the release of ammonia, for example by acid hydrolysis of amino acids, or to facilitate increased volatility of ammonia when heating.

In another embodiment, the pH of the first condensate may be adjusted to facilitate a higher or lower volatility of ammonia when entering the second heater 112. Acidification will reduce volatility and raising pH with increase volatility, each of which may be desirable. The pH adjustment chemical can be added in the first condenser 110 or directly to the first condensate. As a non-limiting example, one acid that could be used is citric acid.

In another embodiment, the first condensate may be concentrated (i.e. reduced in volume) through use of a reverse osmosis, forward osmosis or the combination thereof prior to entry into the second heater 112. The condensate concentration system 111 may be in communication with the first condenser or the tank holding the first condensate and may be configured to perform at least one of a reverse osmosis process and a forward osmosis process. Reverse osmosis is a water purification process that uses a partially permeable membrane to remove ions, unwanted molecules and larger particles from water. Forward osmosis is an osmotic process that, like reverse osmosis, uses a semi-permeable membrane to separate water from dissolved solutes. The driving force for this separation is an osmotic pressure gradient, such that a “draw” solution of high concentration (relative to that of the feed solution), is used to induce a net flow of water through the membrane into the draw solution, thus effectively separating the water from the solutes. In reverse osmosis, an applied pressure is used to overcome osmotic pressure. The first condensate may be concentrated in the condensate concentration system 111 before or after pH adjustment of the first condensate or without any pH adjustment. The first condensate may also be reduced in volume by the RO without prior acidification but the RO concentrate may be acidified prior to the second heater 112. It should be appreciated that water reclaimed by the condensate concentration system 111 may be used in many ways, included within system 100.

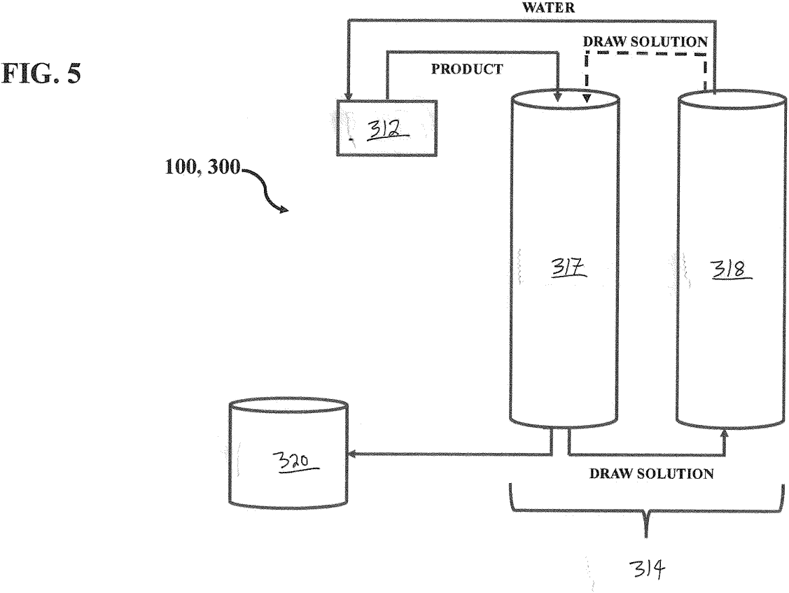

In one particular embodiment, as shown in FIG. 5, the condensate concentration system 111 may be configured with both forward osmosis and the reverse osmosis processes. In this case, a forward osmosis unit 116 dewaters the first condensate by putting water into the draw solution. A reverse osmosis unit 118 processes the draw solution to remove the water. It should also be appreciated that the forward osmosis process may be employed with a multitude of different strategies to regenerate the draw solution.

As used herein, the terms “condense” and “condenser” are defined to include not only processes and devices for conventional condensation of water vapor and ammonia from gaseous to liquid states, but also for transferring gaseous ammonia into liquids such as water, for example, through contact with water in a packed bed with high surface area media.

Different concentrations of ammonia in the second condensate or second concentrate are obtainable by varying the operation of the first heater 108, first condenser 110, second heater 112, and second condenser 114. In certain embodiments, the first and second condensers 110 and 114 are actually multiple condensation units in series, each operating at different temperatures and/or pressures. A skilled artisan may select a suitable number of condensers 110 and 114 and suitable temperatures for any of the condensers 110 and 114, as desired.

In yet another embodiment, it should be understood that Pressure Swing Adsorption (PSA) may be employed instead of, or in addition to, the condensers 110 and 114.

With renewed reference to FIGS. 1 and 5, the collection unit 120 may be in communication with the first heater/evaporator 108, the second heater 112 or the second condenser 114. The collection unit 120 may receive one or more of the effluents from these three components for storage, mixing, and later transport until a desired end use.

It should be appreciated that the system 100 is configured to treat liquid organic waste to form the liquid fertilizer product, which is likewise organic in nature. Desirably, the resultant organic liquid fertilizer product may be an ammonia and water solution, where the concentration of nitrogen in water is greater than about 5% by weight relative to the total weight of the liquid fertilizer product, and more particularly from about 10% to about 23% by weight relative to the total weight of the liquid fertilizer product. In particular, the concentration of nitrogen may be adjusted to be from about 13% to about 23% by weight relative to the total weight of the liquid fertilizer product, and most particularly is about 13% by weight relative to the total weight of the liquid fertilizer product. It should also be appreciated that a concentration of nitrogen greater than 10% by weight relative to the total weight of the liquid fertilizer product may be preferred.

It should be appreciated that the liquid fertilizer product may be combined with additional ingredients to manufacture additional fertilizer products. The additional ingredients may advantageously be natural or organic. For example, the liquid fertilizer product may be combined with other fertilizers, nitrate, Chilean nitrate, microbial products, bacteria, fungus, yeast, mushrooms, minerals, vitamins, guano, dried and powdered blood, ground bone, crushed shells, finely pulverized fish, phosphate rock, coffee grounds, and seaweed. The additional ingredients may be selected by a skilled artisan based on any requirements for a selected end use for the additional fertilizer products.

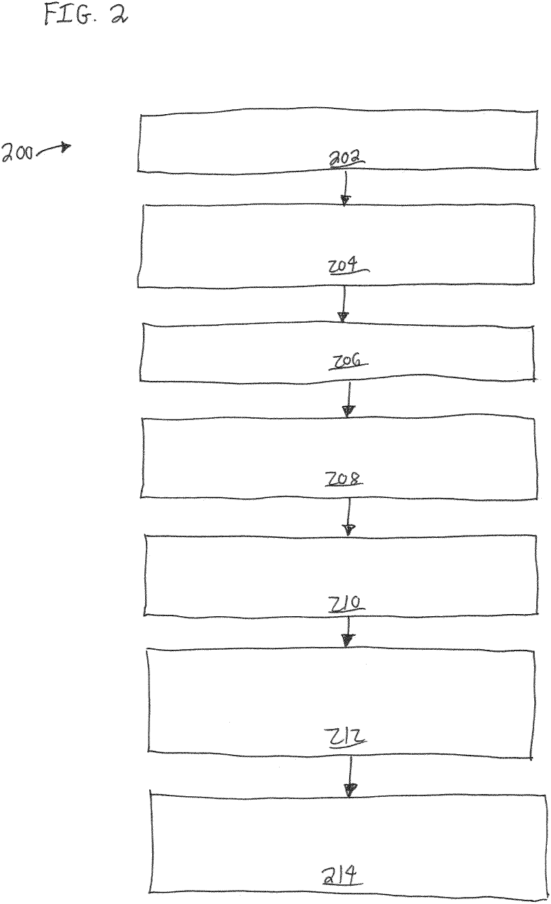

Referring now to FIG. 2, the method 200 for manufacturing the organic liquid fertilizer product may produce the liquid fertilizer product from a liquid organic waste. In particular, the method 200 may utilize the system 100, as described hereinabove, to form the liquid fertilizer product. Although the method 200 is described primarily herein with reference to the associated system 100, for purpose of simplicity, it should be appreciated that other types of systems for executing the method 200 may also be employed within the scope of the present disclosure.

The method 200 may involve a first step 202 of obtaining the liquid organic waste that contains ammoniacal nitrogen. As described hereinabove, the liquid organic waste may desirably be from dairy manure, swine manure, or food waste, although other types of liquid organic waste may also be used. Additionally, the liquid organic waste may also be a dry or semi-dry organic waste, such as chicken manure, which has been mixed with water. The organic liquid waste may be placed in the waste tank 102.

A second step 204 in the method 200 may include an adjusting of the concentration of ammonia in the liquid organic waste. More particularly, the second step 204 may include increasing the concentration ammonia. The second step may involve pumping the liquid organic waste from the waste tank 102 to the concentrator 104. In the concentrator 104, the second step 204 may include at least one of a forward osmosis process, a reverse osmosis process, an anaerobic digestion process, an evaporation process, and a fermentation process. Other suitable processes, or combinations of processes, for adjusting the concentration of the ammonia in the liquid organic waste are also contemplated and considered to be within the scope of the present disclosure.

It should be appreciated that the concentration of ammonia may be increased by one of two methods. A first method may include a decreasing of the amount of water present in the liquid organic waste, and thus, increasing the concentration of ammonia. A second method may include an increasing of the amount of ammonia within the liquid organic waste, thereby, increasing the ammonia concentration. A skilled artisan may select other suitable methods of increasing the concentration of ammonia for the second step 204, as desired.

A third step 206 in the method 200 may include a filtering of the liquid organic waste to obtain the clarified liquid organic waste. In particular, the liquid organic waste may be pumped from the concentrator 104 through the filter 106. The third step 206 may include one of microfiltration and ultrafiltration, as selected by the user. Microfiltration is a type of filtration process where a fluid is passed through a membrane or filter to separate microorganisms and suspended particles from waste liquid. Ultrafiltration is a variety of membrane filtration utilizing membranes with smaller pores than a microfilter. The third step 206 includes removing suspending solids that are larger than about 1 micron, more particularly larger than about 0.1 microns, and most particularly larger than about 0.02 microns. Although these particle sizes may be preferred, it should be appreciated that other suitable filtration particle sizes can also be selected within the scope of the disclosure.

The method 200 may include a fourth step 208 of heating the clarified liquid organic waste to a temperature above 100° F. In particular, the liquid organic waste may be heated to a temperature above 140° F. The clarified liquid organic waste may be heated in the heater/evaporator 108.

The method 200 may have a fifth step 210 of condensing the water vapor and volatile compounds, via the first condenser 110, to form a first condensate.

A sixth step 212 in the method 200 may include heating the first condensate to remove water vapor and volatile compounds, via the second heater/evaporator 112.

The method 200 may include a seventh step 214 of condensing the water vapor and volatile compounds, via the second condenser 112, to form a second condensate rich in ammoniacal nitrogen.

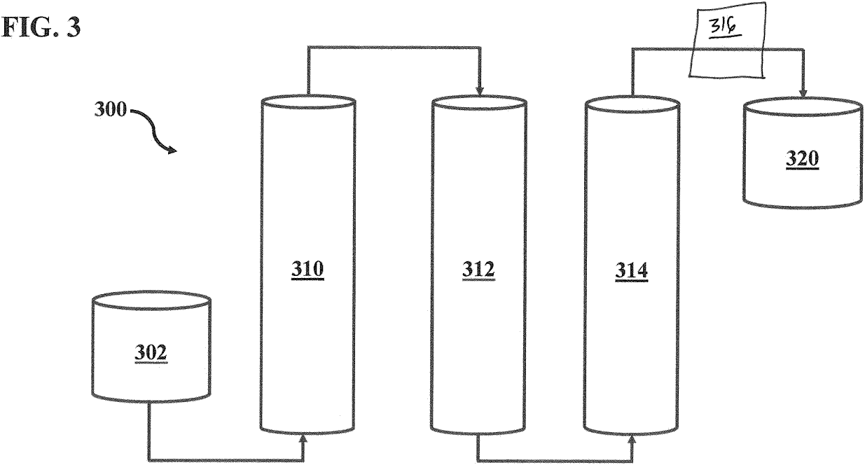

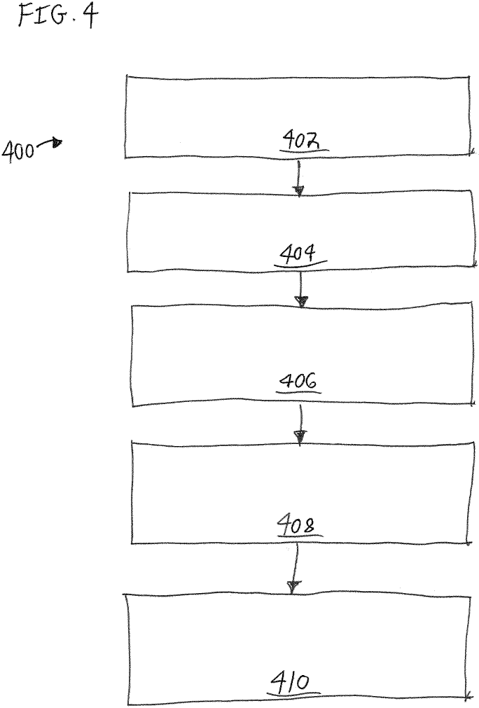

With reference to FIGS. 3 and 4, a system 300 and method 400, according to another embodiment of the present disclosure, for manufacturing the organic liquid fertilizer product from a solid organic waste is shown. As used herein, the term “solid organic waste” is defined to include both completely solid and semi-solid wastes including, for example, wet chicken manure which is known to be about 20-30% dry matter and 70-80% moisture. Like or related structure from FIGS. 1 and 2, which were identified in 100- and 200-series, respectively, are identified in FIGS. 3 and 4 in 300- and 400-series, respectively, for purpose of clarity.

As shown in FIG. 3, the system 300 may include a waste tank 302, a gas remover 310 (e.g., first heater/evaporator 310), a condenser 312, a second heater/evaporator 314, and a second condenser 316, and collection unit 320, each of which may be placed in selective communication via conducts such as pipes, pumps, motors, valves, and the like, which may be selected by the skilled artisan within the scope of the present disclosure. As with the system 100, the system 300 may also be provided with a controller (not shown) and sensors (not shown) that will permit a user to monitor and regulate an operation of the system 300, as described further herein.

The waste tank 302 may be configured to hold a solid organic waste that contains ammoniacal nitrogen. The system 300 may be particularly suited for treatment of solid organic wastes. A particular non-limiting example may be chicken manure; however, one skilled in the art may also select other suitable types of solid organic waste for treatment by the system 300 and the method 400, as desired.

The gas remover 310 is in communication with the waste tank 302. The gas remover 310 is configured to remove gases from the solid organic waste to provide ammonia-containing gas. In one embodiment, the gas remover 310 may be a dryer. The dryer may be configured to apply heat to the solid waste. The heat will cause the ammonia to be released as ammonia-containing gas. Dried solids may be left over in the dryer. Advantageously, the dried solids may be utilized in an additional dry fertilizer product.

The system 300 may further include the condenser 312. The condenser 312 may be in communication with the gas remover 310. The condenser 312 may be configured to process or condense the ammonia-containing gas from the gas remover 310 to form a condensed liquid, and thereby obtain a first condensate.

In certain embodiments, the condenser 312 may be a wet ammonia scrubber 312. The wet ammonia scrubber 312 may be a packed bed wet ammonia scrubber, as a non-limiting example. The wet ammonia scrubber 312 may be a column configured to receive the ammonia-containing gas, for example, from the gas remover 310, near a bottom portion of the column. The column may have a packed bed disposed above the bottom portion of the column. The packed bed may be configured to receive the ammonia-containing gas, while a scrubbing liquid may simultaneously enter the column through a top portion of the column.

It should also be appreciated that the system 300 may contain two or more of the condensers 312 operated in series. A skilled artisan may select a suitable number of condensers 312, as desired.

As described hereinabove, the system 300 may further include the second heater/evaporator 314. The second heater/evaporator 314 may be configured to receive the first condensate product from the condenser 312. The second heater/evaporator 314 may be configured to remove water from the first condensate, and thus, increase an ammonia concentration within the organic liquid fertilizer product. Alternatively, the water vapor and volatile compounds removed in the second heater may condense in the second condenser 316.

As shown in FIG. 5, an additional condensate concentration system (not shown) may be configured to perform at least one of a reverse osmosis process and a forward osmosis process to reduce the volume of the first condensate. It should be appreciated that water reclaimed by this condensate concentration system may be recycled back into the system 300. A skilled artisan may utilize the reclaimed clean water in any suitable manner, as desired.

In one particular embodiment, also shown in FIG. 5, the condensate concentration system may be configured to perform a combination of the forward osmosis process and the reverse osmosis process. The condensate concentration system may have a forward osmosis unit 317, which is configured to receive the condensate product from the first condenser 312. The forward osmosis unit 317 may have a semi-permeable, thin film membrane disposed therein. The forward osmosis unit 317 may be configured to receive the first condensate on a first side of the membrane. A draw solution or osmotic agent may be disposed on an opposite side of the membrane. The draw solution may be a salt solution. Water may selectively pass through the membrane, thereby, increasing the concentration of ammonia in the first side of the membrane. The forward osmosis unit 317 may result in a more concentrated organic liquid fertilizer product.

A reverse osmosis unit 318 may receive the first condensate product from the condenser 312. The reverse osmosis 318 unit may have a semi-permeable, thin film membrane disposed therein. Water may selectively pass through the membrane, resulting in an increase in the ammonia concentration of the organic liquid fertilizer product. It should be appreciated that the clean water reclaimed during this process may be recycled into the system 300. Additionally, the forward osmosis unit 317 and the reverse osmosis unit 318 may be repeatedly used, for example, in a continuous loop, until the desired concentration of ammonia is reached in the liquid organic fertilizer product.

The collection unit 320 of the system 300 may be in fluid communication with the first heater 301, second heater/evaporator 314, and second condenser 316. The collection unit 320 may receive the liquid organic fertilizer product for storage until a desired end use.

It should be appreciated that the system 300 is configured to treat liquid organic waste to form the organic liquid fertilizer product. The organic liquid fertilizer product may be an ammonia and water solution, where the concentration of nitrogen in water is greater than about 5% by weight relative to the total weight of the liquid fertilizer product, and more particularly from about 5% to about 23% by weight relative to the total weight of the liquid fertilizer product. In particular, the concentration of nitrogen may be adjusted to be from about 13% to about 23% by weight relative to the total weight of the liquid fertilizer product, and most particularly from about 13% by weight relative to the total weight of the liquid fertilizer product . It should also be appreciated that a concentration of nitrogen greater than 10% by weight relative to the total weight of the liquid fertilizer product may be preferred.

It should be appreciated that though the liquid fertilizer product may be combined with at least one additional ingredient to manufacture additional fertilizer products. The additional ingredients may advantageously be natural or organic. For example, the liquid fertilizer product may be combined with other fertilizers, nitrate, Chilean nitrate, microbial products, bacteria, fungus, yeast, mushrooms, minerals, vitamins, guano, dried and powdered blood, ground bone, crushed shells, finely pulverized fish, phosphate rock, coffee grounds, and seaweed, or any combination thereof. The additional ingredients and suitable concentrations of the same may be selected by a skilled artisan based on predetermined requirements, for example, a known end use for the additional fertilizer products, as desired.

In another embodiment, as shown in FIG. 4, a method 400 for manufacturing the organic liquid fertilizer product may generate the liquid fertilizer product from a solid organic waste. In particular, the method 400 may utilize the system 300, as described hereinabove, to form the liquid fertilizer product. Although the method 400 is described primarily herein with reference to the associated system 300, for purpose of simplicity, it should be appreciated that other types of systems for executing the method 400 may also be employed within the scope of the present disclosure.

The method 400 may have a first step 402 of obtaining the solid organic waste that contains ammoniacal nitrogen. As described hereinabove, the sold organic waste may desirably be obtained from or as chicken manure. The organic liquid waste may be placed in the waste tank 302.

The method 400 may have a second step 404 of heating the waste to removing gases from the solid organic waste to form the ammonia-containing gas. The solid waste may be heated in the gas remover 310, which as non-limiting examples, may be the dryer, as described hereinabove. It should be appreciated that the removing step 404 is configured to volatilize the ammonia within the solid organic waste. Importantly, the second step 404, and ultimately, the volatilization of ammonia may be performed without an addition of an acid or a base.

A third step 406 in the method 400 may be performed by the condenser 312. The result of the third step 406 is the first condensate.

The method 400 may include a fourth step 408 of heating the first condensate. The fourth step 408 may be performed with the second heater/evaporator 314, as described hereinabove.

The method 400 may include a fifth step 410 of condensing the water vapor and volatile compounds generated by the second heater 314.

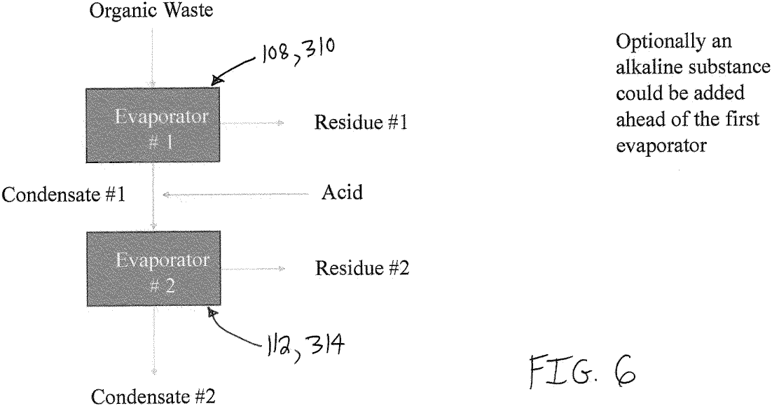

In another embodiment, as shown in FIGS. 6-10, a method and system to produce ammonia-containing fertilizer products with varying levels of non-ammonia salt content from organic wastes is disclosed. The method may include separately concentrating the ammonia and non-ammonia salts. These separate concentrates may be recombined into a single final fertilizer product or may be left as two distinct concentrates. The method enables creation of a cost-effective fertilizer production from organic wastes with controlled levels of salt.

With reference to FIGS. 1-5 and also to FIGS. 6-10, the method may begin with the addition of raw or whole organic waste, examples of which are well known to those of skill in the art and may be described herein, or clarified organic liquid waste produced by removed suspended solids through filtration, as described herein. The organic waste may be contained within a waste tank (e.g., tank 102, 302). The waste tank may be configured to hold the liquid organic waste. In particular examples, the liquid organic waste may be derived from livestock manure, such as dairy manure or pig manure, or food waste. In a most particular example, the waste tank may include a manure holding tank that receives and maintains, for example, with an optional heating equipment, the liquid organic waste at approximately 104° F. However, one of ordinary skill in the art may also select other suitable sources and holding containers for the liquid organic waste within the scope of the present disclosure.

The system and method may include a filter (e.g., filter 106). The filter may be in communication with the waste tank. The filter may be configured to filter the organic waste to obtain a clarified liquid organic waste. Particularly, the filter may be configured to remove suspended solids from the liquid organic waste. The suspended and dissolved solids in the liquid waste may include, but are not limited to nitrogen, phosphorus, potash, secondary nutrients, micro-nutrients and organic matter found in anaerobically digested manure or other agriculturally related organic waste. It should be appreciated that adjusting the temperature of the organic waste may facilitate filtration as well as the dissolution of particulate organic waste into the aqueous solution. Advantageously, the removal of the suspended solids from the liquid organic waste may militate against undesirable clogging in the system 100, in operation.

It should be appreciated that the suspended solids may be removed by the filter via one or more filtration mechanisms including, but not limited to, mechanical screening, microfiltration, ultrafiltration, nanofiltration, reverse osmosis, membrane separation, highspeed mixing (e.g., hydrocyclone), centrifugation, ultrasound and electro-coagulation. It should also be appreciated that a combination of filtration mechanisms may be employed for the filter 106. Natural settling, such as may occur in a lagoon, pond, or tank, is also envisioned as a mechanism to create a clarified liquid organic waste with lower amounts of suspended solids. The liquid organic waste may also be electrified or magnetized to crystalize minerals and reduce scaling on process equipment. Suitable types of filtration will be selected by one skilled in the art, for example, depending on conditions and desired processing considerations within the scope of the present disclosure. It should also be understood that, for wastes with very low levels of suspended solids, no filtration may be required.

In certain embodiments, the filter may be capable of removing suspending solids that are larger than from about 1 micron to about 0.02 microns. In certain embodiments, the filter may be a microfilter. The microfilter may be capable of removing suspended solids larger than about 0.1 microns. In further embodiments, the filter 106 may be an ultrafilter. The ultrafilter may be capable of removing solids larger than about 0.02 microns. A skilled artisan may select other suitable filtration methods and acceptable particle sizes, as desired.

The system may also include a concentrator (e.g., concentrator 104). The concentrator may be configured to receive and adjust the liquid organic waste from the waste tank. In particular, the concentrator may be configured to adjust a concentration of ammonia within the organic liquid waste. Advantageously, the concentrator may reduce an overall volume of liquid, which thereby reduces a total load on the system. The reduction in the total load on the system allows the system to be more efficient and economical compared to the system without a concentrator.

More particularly, the concentrator may be configured to increase the concentration of ammonia in the liquid organic waste. The concentrator may provide this increase in concentration by either removing liquid devoid of ammonia from the liquid organic waste or increasing the availability of ammonia in the liquid organic waste by converting organic sources of ammoniacal nitrogen, such as proteins and amino acids, to ammonia.

Suitable mechanisms for the concentrator may include heat treatment in a tank, natural acid hydrolysis through fermentation, fermentation in the presence of ammonia producing organisms, anaerobic digestion, aerobic digestion, forward osmosis, reverse osmosis, evaporation, and combinations thereof. For example, livestock manure when anaerobically digested at between 95° F. and 103° F. for at least 10 days typically has a higher nitrogen content compared to raw untreated manure as some organic nitrogen is converted into ammonium in the liquid waste. A skilled artisan may select other suitable mechanisms for the concentrator within the scope of the present disclosure in order to increase the concentration of ammonia within the liquid organic waste.

It should be understood that a combination of the concentrator and the filter of the system may produce a clarified liquid organic waste. The clarified liquid organic waste has a desirably low suspended solids content and a desirably high concentration of ammonia. Advantageously, the clarified liquid organic waste may not only run more efficiently through a remainder of the system, but may also produce an organic liquid fertilizer product, which has a greater concentration of aqueous nitrogen compared to known waste treatment systems.

In one embodiment, the whole or pre-filtered waste may then be pumped into an evaporator (108) without acidification. The evaporation process may be any process suitable for removing water from the composition. In a preferred embodiment, the composition is in a liquid form following the evaporation step. Preferably, a multi-effect evaporator is used, such as the Alfa Flash system (Alfa Laval). The evaporation process requires heat to remove water from the composition and the temperature will be dependent on the pressure maintained in the effects. The temperature range of the evaporation process is preferably from about 140-212° F.

The waste may be evaporated in a multi-effect thermal evaporator with or without vacuum, or it can be evaporated in a mechanical vapor recompression (MVR) evaporator powered by electricity. The first evaporator (108) may produce a first condensate and a first evaporator residue. Since the pH is not adjusted prior to the first evaporator, the majority of the ammonia may volatilize and then condense into the first condensate. The first residue may contain mainly salts and organics that are not volatile.

If a solid or semi-solid salt product is desired, a centrifuge or filter press or other suitable instrument may be used in fluid connection with the first evaporator (108) such that solids may be removed as they precipitate and the liquid (e.g., centrate) may be returned to the evaporator such that the only two products of the combined system may include the first condensate and solid product.

The first condensate may be rich in ammonia but contains very few other salts. In some embodiments, it may be readily adjusted with citric acid or another suitable organic acid to a lower pH (e.g, pH 5-6.5) prior to additional concentration. The pH-adjusted first condensate may be evaporated directly in a second evaporator (112) to produce a high-ammonia second residue/concentrate, or it may first be concentrated (via condensate concentration system 111) by reverse osmosis (RO) to reduce the volume of the pH-adjusted first condensate prior to the second evaporator (112). The first condensate may also be reduced in volume by the RO without prior acidification but the RO concentrate may then be acidified prior to the second evaporator (112). This RO may produce a clean RO permeate, which is water that may be reused or discharged, and a RO concentrate rich in ammonia that may be evaporated in the second evaporator (112). Additional acid may be added to the RO concentrate prior to the second evaporator if needed. In one embodiment, the RO concentrate is the final fertilizer product with an ammonia-N content greater than 4% and can be 3% to 12%.

The second evaporator (112) may produce a second residue/concentrate that contains the majority of the ammonia-N in the process and may be a desirable fertilizer product. Typically, the ammonia-N content is greater than 4% and can be 3% to 12%. The second residue may be used directly as a fertilizer product but may also be combined, if desired, with the first evaporator residue. By varying the amount of the first evaporator residue added to the second evaporator residue, the salt content of the final fertilizer product may be precisely controlled.

It should be appreciated that the first and second evaporation steps may be identical. In other words, the two different evaporation steps may include the same temperatures and pressures. Alternatively, the two evaporation steps may include differences in either or both temperature and/or pressure. In other words, the temperatures and/or pressures in each of the evaporation steps may be different. These differences may be modulated based on the desired end product. By way of example, the evaporation temperature may be higher in the first evaporation step to more easily isolate ammonia, and may also not include a vacuum, while the second evaporation step may include lower temperatures and a vacuum to lower the volatility of the ammonia.

It should be appreciated that the fourth step 408 may include only the reverse osmosis process, which is effective at removing excess water as described hereinabove.

In certain embodiments, the first condensate, whether reduced in volume with reverse osmosis or not, may be heated (via second heater 112) without prior acidification to generate a mixture of water vapor and ammonia. This mixture can then be condensed (via second condenser 114) in a controlled manner to produce a final liquid fertilizer product containing greater than 4% nitrogen and can be 3% to 12% nitrogen.

As such and in certain embodiments, the present disclosure provides for methods where when the first condensate is acidified, the fertilizer product is the residue/concentrate from the second evaporator 112. In other embodiments, when the first condensate is not acidified, one can utilize distillation (via second heater 112 and condenser 114) and the fertilizer product is the second condensate.

### EXAMPLES

### Example 1

Effluent from a covered lagoon containing swine manure was obtained. The liquid organic waste was filtered to remove suspended solids using 15-micron screen and a tight UF membrane with a 1 kDa MWCO. The UF permeate was concentrated using reverse osmosis membranes to remove water prior to the first evaporator. The RO concentrate contained 0.62% total nitrogen, the pH of the RO concentrate was 7.8, and the pH was not adjusted prior to evaporation. The first evaporator residue contained about 0.54% total N. The first evaporator condensate was then adjusted to pH 6.5 by adding citric acid and evaporated again to create the second evaporator residue, which contained 8.35% total nitrogen. If desired, further evaporation would have yielded a higher N final product.

### Example 2

Effluent from a dairy manure anaerobic digester was obtained. The liquid organic waste was screw-pressed to remove large fibers and then filtered to remove suspended solids using a tubular UF membrane with a 0.02 micron average pore size. The UF permeate was concentrated using reverse osmosis membranes to remove water prior to the first evaporator. The RO concentrate contained 0.69% total nitrogen, the pH of the RO concentrate was 7.8, and the pH was not adjusted prior to evaporation. The first evaporator residue was 0.25% N and was dehydrated to make a solid fertilizer product. The first evaporator condensate contained 0.72% N and was heated in a distillation system without pH adjustment to create a mixture of water vapor and ammonia. The ammonia and water vapor was condensed as a liquid solution containing 8% N.

While certain representative embodiments and details have been shown for purposes of illustrating the present disclosure, it will be apparent to those skilled in the art that various changes may be made without departing from the scope of the disclosure, which is further described in the following appended claims.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

Although the systems and methods of the present disclosure have been described with reference to exemplary embodiments thereof, the present disclosure is not limited to such exemplary embodiments and/or implementations. Rather, the systems and methods of the present disclosure are susceptible to many implementations and applications, as will be readily apparent to persons skilled in the art from the disclosure hereof. The present disclosure expressly encompasses such modifications, enhancements and/or variations of the disclosed embodiments. Since many changes could be made in the above construction and many widely different embodiments of this disclosure could be made without departing from the scope thereof, it is intended that all matter contained in the drawings and specification shall be interpreted as illustrative and not in a limiting sense. Additional modifications, changes, and substitutions are intended in the foregoing disclosure. Accordingly, it is appropriate that the appended claims be construed broadly and in a manner consistent with the scope of the disclosure.

What is claimed is:

1. A method for manufacturing a liquid fertilizer product, comprising the steps of:
obtaining a liquid organic waste;
removing suspended solids from the liquid organic waste to obtain a clarified liquid organic waste;
heating the clarified liquid organic waste to remove water vapor and volatile compounds, obtaining a salt-rich first concentrate;
condensing the water vapor and volatile compounds to obtain a first condensate;
heating the first condensate to remove water vapor and volatile compounds, obtaining a second concentrate; and
condensing the water vapor and volatile compounds to obtain a second condensate.

2. The method of claim 1, further comprising the step of removing water from the first condensate through membrane filtration to obtain a concentrated first condensate prior to heating the first condensate.

3. The liquid fertilizer product obtained by the method of claim 1 having a total nitrogen content greater than 5% nitrogen.

4. The method of claim 2, further comprising the step of adjusting the pH of the first condensate prior to membrane concentration or the second heating by adding an acidic substance, such as citric acid, acetic acid, elemental sulfur, sulfuric acid, stillage (from ethanol production), or nitric acid.

5. The method of claim 1, further comprising the step of adjusting a concentration of ammoniacal nitrogen in the liquid organic waste before removing suspended solids from the liquid organic waste to obtain the clarified liquid organic waste.

6. The method of claim 5, wherein the step of adjusting the concentration of ammoniacal nitrogen includes at least one of a microfiltration process, ultrafiltration process, forward osmosis process, a reverse osmosis process, an anaerobic digestion process, an aerobic microbial process, an evaporation process, or a microbial fermentation process.

7. The method of claim 1, further comprising the step of adjusting a concentration of ammoniacal nitrogen in the liquid organic waste after removing suspended solids but before heating the clarified liquid waste.

8. The method of claim 7, wherein the step of adjusting the concentration of ammoniacal nitrogen includes at least one of a microfiltration process, ultrafiltration process, forward osmosis process, a reverse osmosis process, an anaerobic digestion process, an aerobic microbial process, or a microbial fermentation process.

9. The method of claim 1, wherein the step of removing suspended solids includes at least one of microfiltration, ultrafiltration, or combinations thereof.

10. The method of claim 1, wherein the liquid organic waste is one of livestock manure and food waste, which is provided one of raw or anaerobically digested.

11. The method of claim 1 wherein more than one of the salt-rich first concentrate, the second condensate, and the second concentrate are combined to some degree to create a mixture for use as a fertilizer.

12. The method of claim 1 wherein the salt-rich first concentrate is dehydrated through centrifugation, filter pressing, or drying to create a semi-solid or solid product.

13. A system for manufacturing a liquid fertilizer comprising:
a waste tank configured to hold a liquid organic waste;
a filter in communication with the waste tank, and configured to filter the organic waste to obtain a clarified liquid organic waste;
a first heater receiving the clarified liquid organic waste, and configured to heat the clarified liquid organic waste to remove water vapor and volatile compounds, obtaining a salt-rich first concentrate;
a condenser configured to condense the water vapor and volatile compounds to obtain a first condensate;
a second heater receiving the first condensate, and configured to heat the first condensate to remove water vapor and volatile compounds, obtaining a second concentrate; and
a second condenser configured to condense the water vapor and volatile compounds to obtain a second condensate.

14. The system of claim 13, wherein the filter is one of an ultrafilter or a microfilter.

15. The system of claim 13, wherein the liquid organic waste is one of livestock manure or food waste, which is provided one of raw or anaerobically digested.

16. The system of claim 13, wherein more than one of the salt-rich first concentrate, the second condensate, and the second concentrate are combinable to create a mixture for use as a fertilizer.

17. The system of claim 13, wherein the mixture has a total nitrogen content greater than 5% nitrogen.

18. The system of claim 13, further comprising a dehydrator, the dehydrator configured to dehydrate the salt-rich first concentrate to create a semi-solid or solid product.

19. The system of claim 18, wherein the dehydrator utilizes centrifugation, filter pressing, or drying.

20. The system of claim 13, further comprising a microbial reactor configured to process the clarified liquid waste and adjust the concentration of ammonia present prior to introduction into the first heater.

21. A method for manufacturing a liquid fertilizer product, comprising the steps of:
obtaining a liquid organic waste;
heating the clarified liquid organic waste to remove water vapor and volatile compounds, obtaining a salt-rich first concentrate;
condensing the water vapor and volatile compounds to obtain a first condensate;
heating the first condensate to remove water vapor and volatile compounds, obtaining a second concentrate; and
condensing the water vapor and volatile compounds to obtain a second condensate.
